(19) United States
(12) Patent Application Publication
(10) Pub. No.: US 2025/0295266 A1
(43) Pub. Date: Sep. 25, 2025

(54) AIR FRYER

(71) Applicant: Tsann Kuen (Zhangzhou) Enterprise Co., Ltd., Zhangzhou City (CN)

(72) Inventors: Yixin ZHAN, Zhangzhou City (CN); Bo WEI, Zhangzhou City (CN)

(21) Appl. No.: 19/012,989

(22) Filed: Jan. 8, 2025

(30) Foreign Application Priority Data
Mar. 21, 2024 (CN) 202420558667.2

(51) Int. Cl. A47J 37/06

(52) U.S. Cl. CPC A47J 37/0641

(57) ABSTRACT

The disclosure provides an air fryer, including a main body and an inner pot. A heat shield of the main body has a first accommodating chamber, a second accommodating chamber and a bottom opening that are sequentially arranged from top to bottom and are in communication with each other. A caliber of the second accommodating chamber is greater than a caliber of the first accommodating chamber. The first accommodating chamber is equipped with blades of a fan inside. The second accommodating chamber is equipped with a heating member inside. A side wall of the second accommodating chamber is a vertical side wall. Cooking efficiency is effectively improved.

### CROSS-REFERENCE TO RELATED APPLICATIONS

This application claims priority to Chinese Patent Application 202420558667.2, filed on Mar. 21, 2024, which is incorporated herein by reference.

### TECHNICAL FIELD

The disclosure relates to an air fryer.

### BACKGROUND

An air fryer is a kitchen appliance that heats and cooks food with high-temperature air. Since the food cooked by the air fryer tastes like fried food but contains less oil, it is delicious and healthy. As a result, the air fryer is becoming more and more popular.

For example, Chinese patent No. CN217429814U discloses an air fryer. In this air fryer, side walls of an air shield (i.e., heat shield) are all inclined side walls, so that hot air on the edge is first blown to a side wall of an inner pot and then bounced back to the food by the side wall of the inner pot, causing heat loss. Thereby, the food is not cooked by heat at the first time, causing low cooking efficiency and an unsatisfactory cooking effect.

### SUMMARY

In view of this, in order to solve the above problem, the disclosure provides an air fryer.

In order to achieve the above objective, the disclosure provides the following technical solution:

An air fryer includes a main body and an inner pot. The main body has an insertion chamber, and the inner pot is optionally arranged in the insertion chamber of the main body or located outside the insertion chamber of the main body. The main body has a heat shield located above the insertion chamber. The heat shield has a first accommodating chamber, a second accommodating chamber and a bottom opening that are sequentially arranged from top to bottom and are in communication with each other, a caliber of the second accommodating chamber is greater than a caliber of the first accommodating chamber, the first accommodating chamber is equipped with blades of a fan inside, the second accommodating chamber is equipped with a heating member inside, and a side wall of the second accommodating chamber is a vertical side wall.

Further, the heating member has a diameter greater than that of the blades so as to completely cover the blades in a vertical direction.

Further, the heating member also has the diameter greater than the caliber of the first accommodating chamber so as to cover the first accommodating chamber in the vertical direction.

Further, a distance between an outermost layer of the heating member and the vertical side wall of the second accommodating chamber is 5-10 mm.

Further, a vertical depth of the second accommodating chamber is greater than a vertical depth of the first accommodating chamber.

Further, the heating member is a planar heating tube obtained by spirally bending a heating tube in a horizontal plane.

Further, the vertical side wall of the second accommodating chamber and the bottom opening are transitioned through a first chamfer, and a distance between a bottom of the heating member and the bottom opening is twice a vertical distance of the first chamfer; and the distance between the bottom of the heating member and the bottom opening is greater than a thickness of the heating member.

Further, a side wall of the first accommodating chamber is an inclined side wall inclined outward from top to bottom.

Further, a top of the heat shield is provided with a dodging hole, the fan is arranged at the top of the heat shield, and a rotating shaft of the fan extends into the first accommodating chamber via the dodging hole of the heat shield and is connected to the blades.

The technical solution provided by the disclosure has the following beneficial effects:

The side wall of the second accommodating chamber is provided as the vertical side wall perpendicular to the bottom opening so as to guide the hot air heated by the heating member vertically downward, so that the hot air is directly blown to food and the food is cooked by heat at the first time, thereby reducing heat loss, effectively improving cooking efficiency and achieving a better cooking effect.

### BRIEF DESCRIPTION OF DRAWINGS

FIG. 1 is a schematic structural view I of an air fryer according to an example, where an inner pot is arranged in an insertion chamber of a main body;

FIG. 2 is a schematic structural view II of the air fryer according to an example, where the inner pot is located outside the insertion chamber of the main body;

FIG. 3 is a sectional view of the air fryer according to an example;

FIG. 4 is a schematic view of a partial structure shown in FIG. 3;

FIG. 5 is a schematic view I showing an appearance of a heat shield according to an

example; and

FIG. 6 is a schematic view II showing the appearance of the heat shield according to an example.

### DESCRIPTION OF EMBODIMENTS

To further illustrate the examples, the accompanying drawings are provided in the disclosure. These accompanying drawings are a part of the contents disclosed in the disclosure that are mainly used to illustrate the examples, and can be used in conjunction with the related descriptions in the specification to explain the operation principle of the examples. With reference to these contents, those of ordinary skill in the art should be able to understand other possible embodiments and advantages of the disclosure. Components in the drawings are not drawn to scale, and like component symbols are usually used to represent like components.

In the description of the disclosure, the orientation or positional relationship indicated by the term “upper”, “lower”, “left”, “right”, “front”, “rear” or the like is based on the orientation or positional relationship shown in the accompanying drawings. This is only for the convenience of describing the disclosure and simplifying the description, and does not indicate or imply that the device or element must have a specific orientation, or be constructed and operated in a specific orientation, and therefore cannot be understood as a limitation of the disclosure.

The disclosure will be further described in conjunction with the accompanying drawings and specific embodiments.

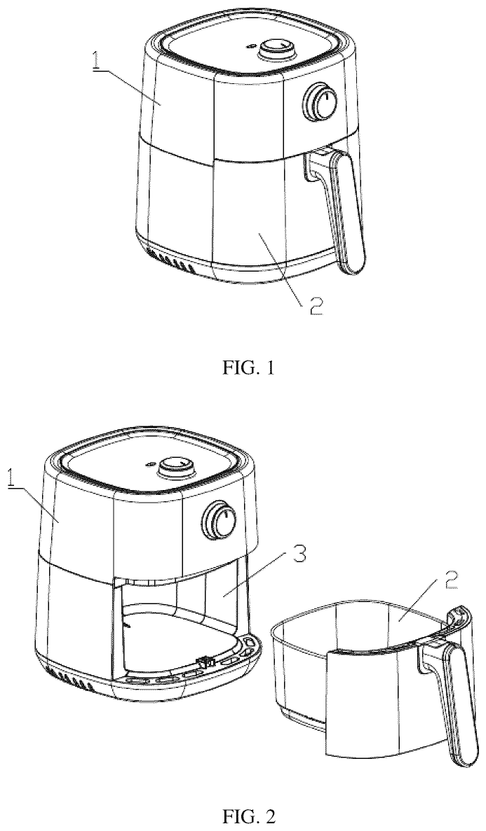

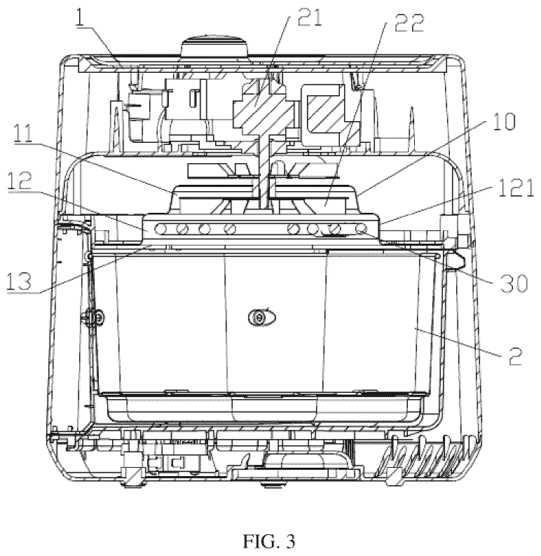

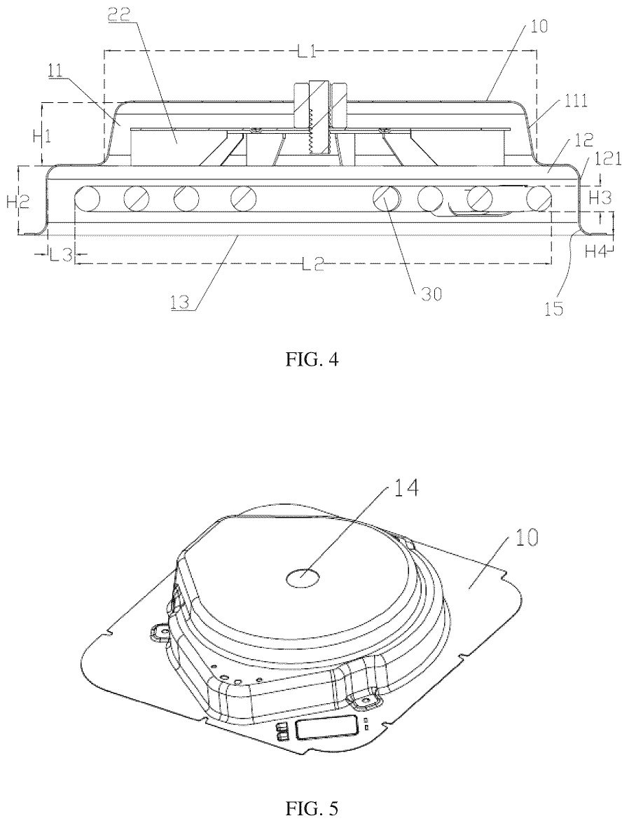

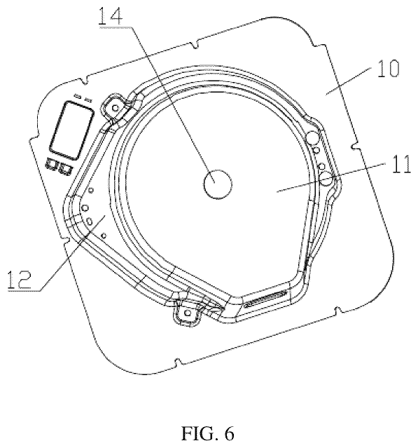

As shown in FIG. 1 to FIG. 6, this example provides an air fryer, including a main body 1 and an inner pot 2. The main body 1 has an insertion chamber 3. The inner pot 2 is a cooker for containing food. The inner pot 2 is optionally arranged in the insertion chamber 3 of the main body 1 or located outside the insertion chamber 3 of the main body 1. For example, the inner pot 2 containing food is placed into the insertion chamber 3 of the main body 1, and after the food is cooked, the inner pot 2 is taken out.

The main body 1 has a heat shield 10 located above the insertion chamber 3, and when the inner pot 2 is arranged in the insertion chamber 3 of the main body 1, the heat shield 10 is also located above the inner pot 2.

The heat shield 10 has a first accommodating chamber 11, a second accommodating chamber 12 and a bottom opening 13 that are sequentially arranged from top to bottom and are in communication with each other, a caliber of the second accommodating chamber 12 is greater than a caliber LI of the first accommodating chamber 11, and the first accommodating chamber 11 is equipped with blades 22 of a fan 21 inside. Specifically, a top of the heat shield 10 is provided with a dodging hole 14, the fan 21 is arranged at the top of the heat shield 10, and a rotating shaft of the fan 21 extends into the first accommodating chamber 11 via the dodging hole 14 of the heat shield 10 and is connected to the blades 22. The second accommodating chamber 12 is equipped with a heating member 30 inside, and a side wall 121 of the second accommodating chamber 12 is a vertical side wall, i.e., the side wall 121 of the second accommodating chamber 12 is provided vertically downward.

During cooking, the blades 22 are driven by the fan 21 to rotate so as to form air flows, the air flows flow from the first accommodating chamber 11 to the second accommodating chamber 12 and are heated by the heating member 30 to form hot air, and the hot air is blown downward to the food in the inner pot 2 after passing through second accommodating chamber 12 and the bottom opening 13. During this process, since the side wall 121 of the second accommodating chamber 12 is the vertical side wall that can guide the hot air vertically downward, the hot air is directly blown to the food, and the food is cooked by heat at the first time, thereby reducing heat loss, effectively improving cooking efficiency and achieving a better cooking effect.

Preferably, the heating member 30 has a diameter L2 greater than that of the blades 22 so as to completely cover the blades 22 in a vertical direction. In this way, the air flows blown directly downward by the blades 22 can all enter the heating member 30 and be heated to form the hot air. Further, the heating member 30 also has the diameter L2 greater than the caliber L1 of the first accommodating chamber 11 so as to cover the first accommodating chamber 11 in the vertical direction. In this way, both the air flows blown directly downward by the blades 22 and the air flows guided downward by the side wall 111 of the first accommodating chamber 11 can enter the heating member 30 and be heated to form the hot air, thereby achieving a better heating effect.

A side wall 111 of the first accommodating chamber 11 is an inclined side wall inclined outward from top to bottom. In this way, the inclined side wall can better guide the air flows downward to the second accommodating chamber 12. Of course, in other examples, the side wall 111 of the first accommodating chamber 11 may also be a vertical side wall or the like.

A distance L3 between an outermost layer of the heating member 30 and the vertical side wall (i.e., the side wall 121) of the second accommodating chamber 12 is 5-10 mm, so that the second accommodating chamber 12 can be well covered while the heating member 30 can be prevented from being too close to the heat shield 10 such that excessive heat generated by the heating member 30 is conducted to the heat shield 10, thereby protecting the other components.

A vertical depth H2 of the second accommodating chamber 12 is greater than a vertical depth H1 of the first accommodating chamber 11, so that it is easier to concentrate the air flows blown downward in the second accommodating chamber 12.

Specifically, in this example, the heating member 30 is a planar heating tube obtained by spirally bending a heating tube in a horizontal plane. A thickness H3 of the heating member 30 is a diameter of the heating tube. The vertical side wall 121 of the second accommodating chamber 12 and the bottom opening 13 are transitioned through a first chamfer 15, and a distance H4 between a bottom of the heating member 30 and the bottom opening 13 is twice a vertical distance of the first chamfer 15; and the distance H4 between the bottom of the heating member 30 and the bottom opening 13 is greater than the thickness H3 of the heating member 30 (i.e., the diameter of the heating tube). In this way, the hot air can enter the inner pot 2 more effectively, thereby reducing heat loss. Moreover, the heated temperature of the food is close to the controlled temperature of the heating member 30, thereby achieving a better cooking effect.

This embodiment has specifically shown and introduced the disclosure, but it should be understood by those skilled in the art that various changes made thereto in forms and details without departing from the spirit and scope of the disclosure as defined in the appended claims shall fall within the scope of protection of the disclosure.

1. An air fryer, comprising a main body and an inner pot, wherein the main body has an insertion chamber, the inner pot is arranged in the insertion chamber of the main body or located outside the insertion chamber of the main body, the main body has a heat shield located above the insertion chamber, the heat shield has a first accommodating chamber, a second accommodating chamber and a bottom opening that are sequentially arranged from top to bottom and are in communication with each other, a caliber of the second accommodating chamber is greater than a caliber of the first accommodating chamber, the first accommodating chamber is equipped with blades of a fan inside, the second accommodating chamber is equipped with a heating member inside, and a side wall of the second accommodating chamber is a vertical side wall.

2. The air fryer according to claim 1, wherein the heating member has a diameter greater than that of the blades so as to completely cover the blades in a vertical direction.

3. The air fryer according to claim 2, wherein the diameter of the heating member is also greater than the caliber of the first accommodating chamber so as to cover the first accommodating chamber in the vertical direction.

4. The air fryer according to claim 1, wherein a distance between an outermost layer of the heating member and the vertical side wall of the second accommodating chamber is 5-10 mm.

5. The air fryer according to claim 2, wherein a distance between an outermost layer of the heating member and the vertical side wall of the second accommodating chamber is 5-10 mm.

6. The air fryer according to claim 3, wherein a distance between an outermost layer of the heating member and the vertical side wall of the second accommodating chamber is 5-10 mm.

7. The air fryer according to claim 1, wherein a vertical depth of the second accommodating chamber is greater than a vertical depth of the first accommodating chamber.

8. The air fryer according to claim 1, wherein the heating member is a planar heating tube obtained by spirally bending a heating tube in a horizontal plane.

9. The air fryer according to claim 1, wherein the vertical side wall of the second accommodating chamber and the bottom opening are transitioned through a first chamfer, a distance between a bottom of the heating member and the bottom opening is twice a vertical distance of the first chamfer, and the distance between the bottom of the heating member and the bottom opening is greater than a thickness of the heating member.

10. The air fryer according to claim 8, wherein the vertical side wall of the second accommodating chamber and the bottom opening are transitioned through a first chamfer, a distance between a bottom of the heating member and the bottom opening is twice a vertical distance of the first chamfer, and the distance between the bottom of the heating member and the bottom opening is greater than a thickness of the heating member.

11. The air fryer according to claim 1, wherein a side wall of the first accommodating chamber is an inclined side wall inclined outward from top to bottom.

12. The air fryer according to claim 1, wherein a top of the heat shield is provided with a dodging hole, the fan is arranged at the top of the heat shield, and a rotating shaft of the fan extends into the first accommodating chamber via the dodging hole of the heat shield and is connected to the blades.
